(19) United States
(12) Patent Application Publication
(10) Pub. No.: US 2007/0081070 A1
(43) Pub. Date: Apr. 12, 2007

(54) Optical medium recording

(76) Inventors: Kuohua Wu, Corvallis, OR (US); Darwin M. Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/249,824

(22) Filed: Oct. 12, 2005

(51) Int. Cl. B41J 2/435

(52) U.S. Cl. 347/224

(57) ABSTRACT

One embodiment of an optical medium recording apparatus includes an optical medium support including a support surface, a first light source that projects a first recording light beam focused at a first position relative to the support surface, and a second light source that projects a second recording light beam focused at a second position relative to the support surface, the second position different from the first position, wherein the first recording light beam and the second recording light beam are both projected to the support surface in a single direction.

An optical medium, such as a CD or a DVD, may be recorded with digital data such as computer programs, music, photos, and movies. The optical medium may also be recorded with a visible label that identifies the contents of the digital data. Decreasing the time required to record the digital data and the visible label on the optical medium, and reducing the complexity of user interactions associated with the recording process, may be advantageous.

### BRIEF DESCRIPTION OF THE DRAWINGS

FIG. 1 is a schematic cross-sectional side view of one embodiment of an optical medium recording apparatus according to the present invention.

FIG. 2 is a schematic cross-sectional side view of another embodiment of an optical medium recording apparatus according to the present invention.

FIG. 3 is a schematic graph showing a recording sequence of one embodiment of an optical medium recording method.

FIG. 4 is a flowchart showing one embodiment of a method of recording an optical medium.

### DETAILED DESCRIPTION OF THE DRAWINGS

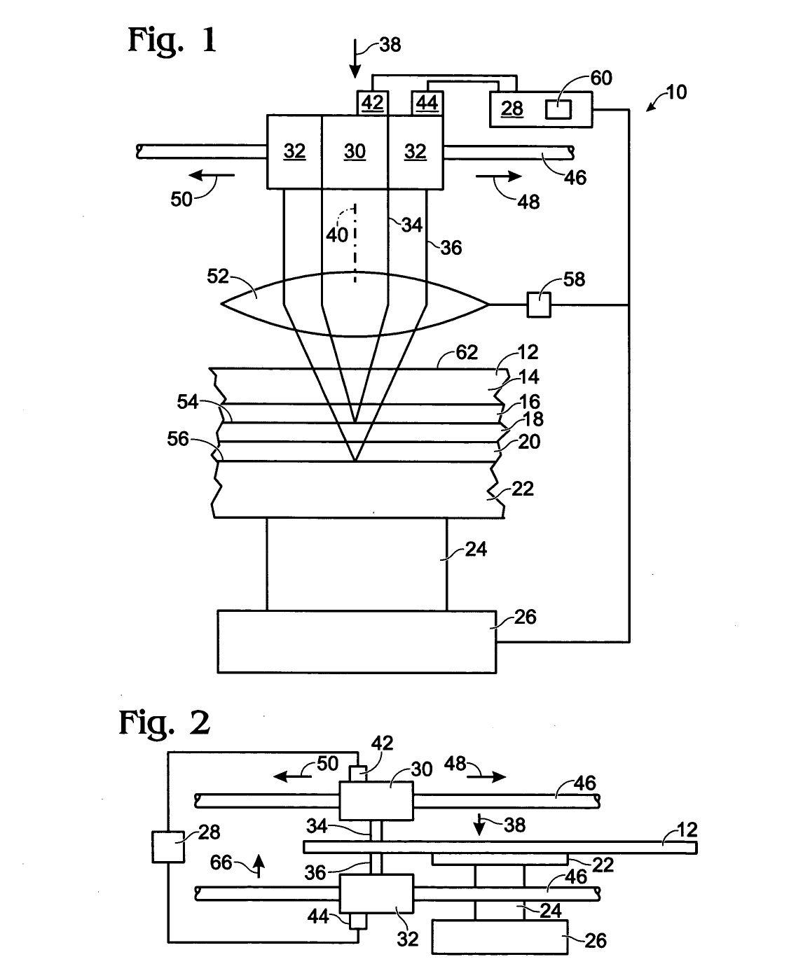

FIG. 1 is a schematic cross-sectional side view of one embodiment of an optical medium recording system 10 for recording digital data and a visible label on an optical medium 12. Optical medium 12 may be a CD (compact disc, such as a CD-R or a CD-RW format), DVD (digital versatile disc, such as a DVD-R, DVD-RW, DVD+R, DVD+RW, HD, or Blu-Ray format), or similar media that may be recorded with digital data, such as binary data. Such binary data may include, for example, computer readable code, music, pictures, movies, and the like. The visible label recorded on medium 12 may include graphics and/or text such as a title for a live broadcast, song or story titles, the length of each song or story, the song artist or story author, the production company that produced and/or recorded the song or story, an image of the album or an image from the live broadcast, and any other such information as may be desirable to a user of the optical medium.

Medium 12 may include multiple layers such as a substrate 14, a data recording layer 16, a spacing layer 18, and a label recording layer 20. Spacing layer 18 may have selectively transmissive or selectively reflective properties so as to allow only light in a particular range of wavelengths to penetrate therethrough. Optical medium 12 may be supported on a support 22, such as a rotating support. Support 22 may be positioned on a spindle 24 that is rotated by a spindle motor 26, wherein motor 26 is controlled by a controller 28. Controller 28 may control spindle motor 26 to rotate support 22, and an optical medium 12 positioned thereon, at any desirable speed, such as at a data recording speed or at a label recording speed. For example, in one embodiment, support 22 may be rotated at a label recording linear velocity in a range of 0.5 to 5.0 meters per second (m/s), and more particularly, at a velocity of approximately 1.5 m/s throughout an entire recording process, wherein the label recording speed may also be sufficient to record digital data on medium 12. In another embodiment, support 22 may be rotated alternatingly at a label recording linear velocity of approximately 1.5 m/s, for example, and at a digital data recording angular velocity of 10,000 rpms, such that digital data is recorded on medium 12 while medium 12 is rotated at the digital data recording speed and such that a visible label is recorded on medium 12 while medium 12 is rotated at the label recording speed. The layers of medium 12 may be manufactured by any process, of any material, and in any thickness, as may be desirable for a particular application.

In one embodiment, controller 28 includes a processor 28a coupled to a processor-readable medium such as a memory 28b. The memory 28b may contain processor-executable instructions which, when executed by the processor, cause the processor to control various portions of system 10, such as spindle motor 26, and light beams and tracking systems as will be discussed subsequently.

System 10 may also include first and second optical pickup units (OPUs) 30 and 32, respectively. First OPU 30 may be dedicated to recording digital data on medium 12 and second OPU 32 may be dedicated to recording a visible label on medium 12. First OPU 30 may also read digital data recorded on medium 12. In the embodiment shown in FIG. 1, first OPU 30 is nested within second OPU 32 such that a first beam of light 34 projected by first OPU 30 is nested within a second beam of light 36 projected by second OPU 32. In other words, in this particular embodiment, first beam of light 34 and second beam of light 36 are projected in a single direction 38 along a single light beam axis 40 toward medium 12. In another embodiment, light beams 34 and 36 may not be nested within one another but may be in a desirable calibrated position wherein the two light beams each have a focal point positioned approximately 25 um apart from one another in a direction of axis 40.

First and second OPUs 30 and 32 may each be connected to a motor 42 and 44, respectively, which may each be connected to controller 28. Controller 28 may control the printing/recording functions of each of OPUs 30 and 32, and may also control motors 42 and 44, which may move the OPUs along one or more OPU supporting rails 46. In this manner, controller 28 may control printing of the OPUs 30 and 32 as the OPUs are moved radially in directions 48 and 50 over medium 12, as medium 12 is rotated on spindle 24, such that the light beams may impinge a two-dimensional region of the medium 12.

Still referring to FIG. 1, recording system 10 may further include a focusing element 52, such as a focusing lens, that may function to focus first light beam 34 at a first position 54 and second light beam 36 at a second position 56. In the embodiment shown, first position 54 may be a lower surface of data recording layer 16 of medium 12 and second position 56 may be a lower surface of label recording layer 20. Focusing element 52 may be connected to a motor 58 that may be connected to and controlled by controller 28. During operation of system 10, light beams 34 and 36 may be projected by OPUs 30 and 32, respectively, and focused by focusing element 52 such that first light beam 34 is controllably impinged onto a desired location of data recording layer 16 for a sufficient time and at a sufficient intensity to cause a phase change to occur in the material of layer 16 at that location, and such that second light beam 36 is controllably impinged onto a desired location of label recording layer 20 for a sufficient time and at a sufficient intensity to cause a phase change to occur in the material of layer 20 at that location.

In one example, data may be recorded to data recording layer 16 by projecting first wavelength of light 34 to layer 16, such as a wavelength of light in a range of approximately 300 to 850 nanometers (nm), and a visible label may be recorded to label recording layer 20 by projecting second wavelength of light 36 to layer 20, such as a wavelength of light in a range of approximately 420 nm to 1500 nm. The wavelengths may or may not be the same wavelength. In particular, a first wavelength of light 34 of approximately 450 nm may be utilized to record digital data to a blue ray disc, a first wavelength of light 34 of approximately 650 nm may be utilized to record digital data to a DVD disc, and a first wavelength of light 34 of approximately 780 nm may be utilized to record digital data to a CD. A second wavelength of light 36 of approximately 780 nm may be utilized to record a visible label on an optical medium. However, any type or wavelength of light, from any type of light source, may be utilized to record data to data recording layer 16 and to label recording layer 20, in a particular application.

Spacing layer 18 may be a selectively transmissive layer 18, also referred to as a selectively reflective layer 18, and in some embodiments may be manufactured of multiple sub layers of a variety of materials, such as layers of metal, semi-metal, dielectric and/or liquid layers, with different thicknesses in each layer. In some embodiments, layer 18 may have a thickness in a range of 15 nm to 5000 nm. In one embodiment, selectively transmissive layer 18 may include three sublayers including a GaAs layer, a CaF2 layer and another GaAs. In this embodiment, layer 18 may have an eighty percent reflectance and a five percent transmittance at approximately 550 nm, for example, and a ninety percent transmittance and a zero percent reflectance at approximately 1000 nm. Accordingly, in such an embodiment, layer 18 is selectively transmissive at a wavelength of approximately 1000 nm. A first wavelength of light 34, therefore, of approximately 550 nm may be utilized to record data to data recording layer 16 wherein substantially, i.e., at least seventy percent, of the light 34 is reflected by selectively transmissive layer 18 such that the light does not transmit to and does not damage or interfere with label recording on label recording layer 20. Moreover, the high reflectivity of layer 18 may be utilized to selectively reflect light 34 in order to provide focus and tracking servo information as well as to assist in data decoding. Additionally, a second wavelength of light 36 of approximately 1000 nm may be utilized to record a visible label on label recording layer 20 wherein substantially, i.e., at least seventy percent, of the light 36 is transmitted by selectively transmissive layer 18 such that the light enables a visible label to be produced on label recording layer 20. Due to the utilization of different wavelengths of light 34 and 36 to record data to data recording layer 16 and to record a visible label to label recording layer 20, both wavelengths of light may be projected simultaneously to optical medium 12. Moreover, due to the inclusion of selectively transmissive layer 18, both light 34 and 36 can be projected to the same side or surface 62 of optical medium 12 to record the digital data and the visible label, respectively, to medium 12 without turning over or otherwise repositioning of optical medium 120 in an optical media recording mechanism or drive. Accordingly, the time and complexity of recording data and a visible label to medium 12 may be reduced by the inclusion of selectively transmissive layer 18.

System 10 may further include a tracking system 60, which may be a component of controller 28, such as a software program contained within and executed by controller 28. Tracking system 60 may be connected to both OPUs 30 and 32, through controller 28, for example, such that tracking system 60 may allow both the OPUs to track coordinates of medium 12 during recording thereon. In one embodiment, tracking system 60 may be a groove tracking system that tracks a pre-stamp molded, sub-micron spiral track, having a groove width of approximately 0.3 to 5 microns, formed on a top surface 62 of optical medium 12. Use of a groove tracking system to track coordinates of medium 12 during both digital data recording and visible label recording on medium 12 may provide a more accurate/higher resolution tracking system than a system that utilizes a groove tracking system for data recording and a separate tracking system, such as a rotational angle and radial measurement tracking system, for label recording. Moreover, use of a single groove tracking system for both digital data read/write operations and visual label recording operations may reduce the necessity of non-groove tracking system structure, such as a rotational encoding sensor, a marking bar, a disk pre-mapping system and disk pre-scanning steps. Accordingly, use of a single groove tracking system for both digital data read/write operations and visual label recording operations may also reduce the cost, size, and recording time utilized, of the recording system. Moreover, use of a single groove tracking system for both digital data read/write operations and visual label recording may allow a more complex visual label to be recorded than other visual label tracking systems used heretofore. In particular, a high precision groove tracking system may allow labeling the fine grain of a marking media having a sub-micron or nano sized structure.

FIG. 2 shows a second embodiment of a recording system 10 wherein first OPU 30 is positioned above support 22 and second OPU 32 is positioned below support 22. The OPUs may each be moved along their respective support rail 46 by their corresponding motors 42 and 44, as controlled by controller 28. In this embodiment, first beam of light 34 is projected in direction 38 toward optical medium 12 and second beam of light 36 is projected in a second direction 66 toward medium 12. In this embodiment, OPUs 30 and 32 may simultaneously print on medium 12 if the medium is rotated by motor 26 at a speed sufficient for recording on the medium by both OPUs 30 and 32. For example, if medium 12 is rotated at a label recording speed, which may be slower than a standard data recording speed, the data recording process may be slowed to a speed that is sufficient to record data on medium 12 during label recording on medium 12. In another embodiment, the speed of motor 26 may be varied such that data recording by OPU 30 and label recording by OPU 32 may take place in an alternating sequence. In such a process, data may be first recorded to medium 12, then a label may be recorded on medium 12. Thereafter, the sequence may be repeated until recording of the digital data and the label on medium 12 is completed, such as the entirety of a live broadcast program. The sequential recording of the digital data and the visible label may be completed during a live broadcast program by buffering the digital data and then recording the buffered data between label recording times. In this manner, a label may be recorded during a live broadcast such that at the end of the live broadcast, both the live broadcast and an appropriate label are both recorded on medium 12.

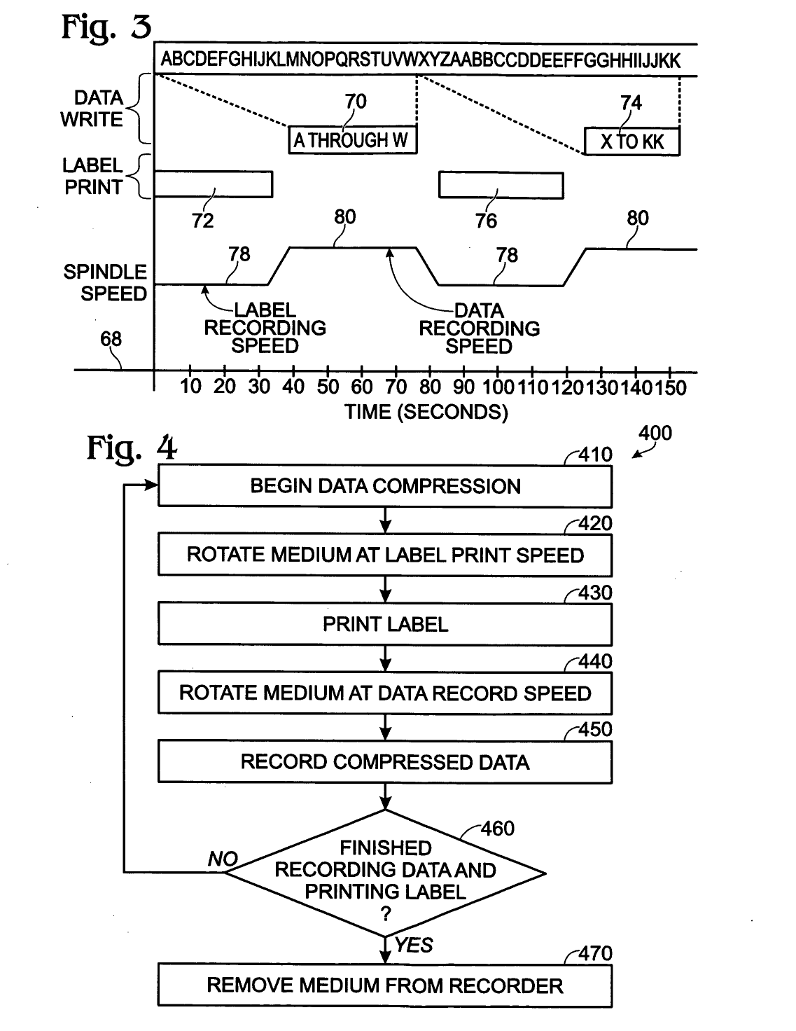

FIG. 3 is a schematic graph 68 showing a recording sequence of one embodiment of an optical medium recording method. Graph 68 shows a data write sequence wherein digital data A through W is buffered into a data bundle 70 during a time period from zero to approximately seventy five seconds. Data bundle 70 may be recorded on an optical medium 12 (see FIG. 1) during a time period of, for example, thirty five through approximately seventy five seconds. During the initial data buffering of data bundle 70, label information 72 may be recorded on optical medium 12 Similarly, during a time period from approximately seventy five seconds through approximately one hundred and fifty seconds, a second data bundle 74 including data X through KK may be buffered. Data bundle 74 may be recorded on an optical medium 12 during a time period of, for example, approximately one hundred twenty five through one hundred and fifty seconds. During the initial data buffering of data bundle 74, label information 76 may be recorded on optical medium 12. During this alternating or interleaved recording of digital data bundles 70 and 74, and visible label information 72 and 76, the speed of spindle 24 (see FIG. 1), which supports optical medium 12, may be changed. In particular, the spindle speed may be set at a label recording speed 78 for approximately the first thirty seconds of the recording process. Thereafter, the speed of spindle 24 may be increased to a data recording speed 80 at approximately forty seconds until approximately seventy seconds, whereafter the speed may be reduced to the label recording speed until approximately one hundred and twenty seconds. Thereafter, the spindle speed may again be increased to the data recording speed. In this manner, label information 72 and 76 may be recorded on an optical medium during a live broadcast program, including live broadcast data A through KK, for example, such that at the conclusion of the live broadcast, the live broadcast data 70 and 74, etc., and corresponding visible label information 72 and 76, etc., will both be recorded on an optical medium.

In one example embodiment of alternating or interleaved recording of digital data bundles and visible label information, the data speed may be approximately 10,000 rpms with a constant linear velocity of the laser of approximately 29 meters per second (m/s). The label speed may be approximately 1,500 millimeters per second (mm/s) with a linear velocity of the laser of approximately 511 rpms at an inner diameter of the optical medium and approximately 247 rpms at an outer diameter of the optical medium (to achieve a constant linear velocity of the laser as it moves outwardly on the optical medium the rotational speed of the optical medium may be reduced). A typical size for a data buffer, which may be included as a part of memory 28b (see FIG. 1) in which compressed data information is stored may be in a range of approximately 2 to 50 megabytes, such as 32 megabytes. In one example, such as during a 7 megabyte per second live broadcast data stream, with a 32 megabyte buffer, the cycle time may be approximately 36 seconds. Accordingly, live broadcast data may be buffered for approximately 30 seconds, and then may be recorded on optical medium 12 for approximately six seconds. During the 30 second buffering time period, visible label information may be recorded on optical medium 12. During the six second data recording time period, recording of visible label information may be temporarily suspended.

In another embodiment, spindle 24 may be rotated at a continuous, single speed, such as at a label recording speed 78, that may facilitate recording of a visible label and recording of digital data on an optical medium at the same time. Accordingly, there may be three different ways to record, including: recording a label and data at a continuous labeling speed of the optical medium; recording a label and data at a continuous data speed of the optical medium; and recording a label and data at alternating speeds of the optical medium wherein the data is compressed into a buffer during label recording, and wherein data recording takes place intermittently between periods of label recording. In each embodiment, wherein at the end of the live broadcast program the live broadcast data and a visible label have both been recorded on an optical medium, the process may be referred to a simultaneous recording of the label and the digital data on the optical medium. In other words, a user operating recording system 10 will be provided with an optical medium 12 at the conclusion of the live broadcast that includes both the live broadcast and a visible label.

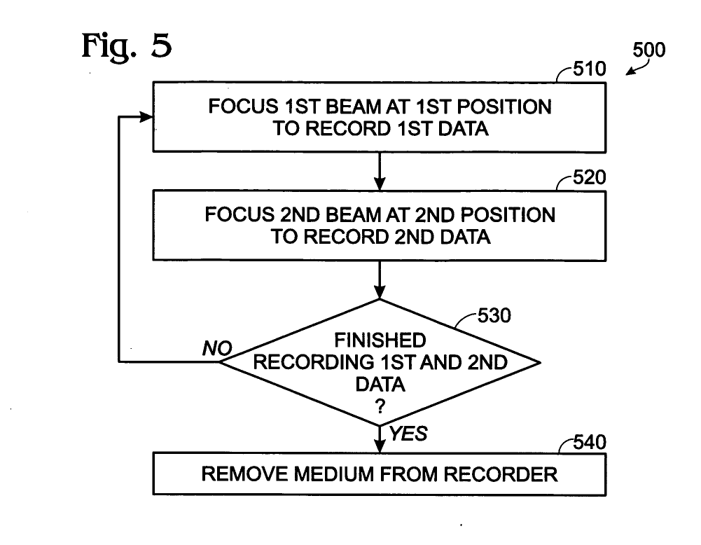

FIG. 4 is a flowchart showing one embodiment of a method 400 of recording an optical medium. In this method data may first be buffered at 410, such as digital data from a live broadcast. At 420, an optical medium may then be rotated at a label recording or label printing speed. At 430, a label or a portion thereof may then be recorded or printed on the medium. At 440, the medium may then be rotated at a data recording speed. At 450, the buffered digital may then be recorded on the medium. If at 460 there is more digital data or label information to be recorded on the medium, for example, if a live broadcast to be recorded is still ongoing, the sequence can be repeated starting at 410 until the live broadcast is complete. Once the live broadcast and the visible label are completely recorded on the optical medium, which may coincide with the end of the live broadcast, then at 470 the medium may be removed from the recorder. In this manner, a visible label is printed on the optical medium simultaneous with recording of digital data, such as a live broadcast program.

FIG. 5 is a flowchart showing another embodiment of a method 500 of recording an optical medium. In this method at 510 a first beam may be focused at a first position to record first data, such as live broadcast data. At 520 a second beam may be focused at a second position to record second data, such as a visible label. If at 530 there is more digital data or label information to be recorded on the medium, for example, if a live broadcast to be recorded is still ongoing, the sequence can be repeated starting at 510. Once the live broadcast and the visible label are completely recorded on the optical medium, which may coincide with the end of the live broadcast, then at 540 the medium may be removed from the recorder. In this manner, a visible label is printed on the optical medium simultaneous with recording of digital data, such as a live broadcast program.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

We claim:

1. An optical medium recording apparatus, comprising:
a data recording OPU positionable adjacent a side of an optical medium and configured to emit a first light beam of a first wavelength focused onto a data layer of the medium so as to write digital data to or read digital data from the medium;
a label recording OPU positionable adjacent the side of the optical medium and configured to emit a second light beam of a second wavelength focused onto a labeling layer of the medium different from the data layer so as to form a visible label of the medium; and
a tracking system connected to said data recording OPU and to said label recording OPU, wherein said tracking system tracks coordinates of the medium during both data writing or reading and label recording.

2. The apparatus of claim 1, wherein the first and second light beams are simultaneously applied to a substantially identical region of the optical medium, the first light beam substantially inhibited from impinging the label recording layer by a selectively transmissive layer of the optical medium.

3. The apparatus of claim 2, wherein the selectively transmissive layer is disposed between the data recording layer and the label recording layer of the optical medium.

4. The apparatus of claim 1 wherein said tracking system comprises a groove tracking system.

5. The apparatus of claim 1 wherein said tracking system includes a groove tracking servo motor and a focus servo motor.

6. The apparatus of claim 1 wherein said data recording OPU and said label recording OPU each record on an optical medium during a live broadcast program.

7. An optical medium recording apparatus, comprising:
an optical medium support including a support surface;
a first light source that projects a first recording light beam focused at a first position relative to said support surface; and
a second light source that projects a second recording light beam focused at a second position relative to said support surface, said second position different from said first position, wherein said first recording light beam and said second recording light beam are both projected to said support surface in a single direction.

8. The apparatus of claim 7 wherein said first recording light beam and said second recording light beam are each centered on a single light beam axis.

9. The apparatus of claim 7 wherein said first recording light beam is centered on a first light beam axis and said second recording light beam is centered on a second light beam axis different from said first light beam axis.

10. The apparatus of claim 7 further comprising a single focusing element, and wherein said first recording light beam and said second recording light beam are each projected through said single focusing element and toward said support surface.

11. The apparatus of claim 10 wherein said first recording light beam and said second recording light beam are each projected simultaneously through said single focusing element.

12. The apparatus of claim 7 wherein said first recording light beam defines a label recording light beam and said second recording light beam defines a data recording light beam.

13. The apparatus of claim 7 wherein said first and second recording light beams each have a wavelength different from one another and wherein said first and said second recording light beams each have a wavelength in a range of 420 nm to 1500 nm.

14. The apparatus of claim 7 wherein a spacing between said first position and said second position is equal to a thickness of a spacing layer of an optical medium usable with said apparatus.

15. A method of recording an optical medium, comprising:
projecting a first recording light beam focused at a first position relative to an optical medium support surface; and
projecting a second recording light beam focused at a second position relative to said support surface, said second position different from said first position,
wherein said first recording light beam and said second recording light beam are both projected to said support surface in a single direction.

16. The method of claim 15 further including tracking a spiral groove of an optical medium supported on said support surface.

17. The method of claim 15 further comprising recording live broadcast data from a live broadcast on an optical medium supported on said support surface.

18. The method of claim 17 further comprising recording a visible label on said optical medium.

19. The method of claim 18 wherein said live broadcast data and said visible label are both printed on said optical medium during said live broadcast.

20. The method of claim 19 wherein said live broadcast data and said visible label are both recorded with light projected along a single light axis, wherein a first portion of said light is focused on a first layer of said optical medium to record said live broadcast data thereon and a second portion of said light is focused on a second layer of said optical medium to record said visible label thereon.

21. A method of recording an optical medium with content from a live program, comprising:
recording said live program on said optical medium during broadcast of said live program; and
recording a label on said optical media during broadcast of said live program,
wherein said optical medium is rotated alternatingly at a label recording speed and at a data recording speed and wherein said live program is recorded on said optical medium while said optical medium is rotated at said data recording speed and said label is recorded on said optical medium while said optical medium is rotated at said label recording speed.

22. The method of claim 21 wherein data from said live program is buffered and then recorded on said optical medium while said optical medium is rotated at said data recording speed.

23. An optical medium recording apparatus, comprising:
means for supporting an optical medium;
means for projecting a first light beam in a first direction and focused at a first position relative to said means for supporting; and
means for projecting a second light beam in said first direction and focused at a second position relative to said means for supporting,
wherein said first light beam projects live digital data information of a live broadcast to said first position during said live broadcast and said second light beam projects visible label information to said second position during said live broadcast.

24. The apparatus of claim 23 wherein said second position is different from said first position and said first and second light beams are both projected in a single direction.

25. The apparatus of claim 23 further comprising means for tracking connected to said means for projecting said first light beam and to said means for projecting said second light beam, wherein said means for tracking tracks coordinates of an optical medium supported on said means for supporting during projection of said first and said second light beams.

26. The apparatus of claim 25 further comprising means for focusing said first light beam and said second light beam at said first and second positions, respectively.

27. The apparatus of claim 26 further comprising means for controlling operatively connected to a servo motor of said means for tracking and to a servo motor of said means for focusing.

28. A processor-readable medium having processor-executable instructions thereon which, when executed by a processor, cause the processor to:
receive a live broadcast;
rotate an optical medium at a data recording speed;
record the live broadcast on the optical medium during the live broadcast;
rotate the optical medium at a label recording speed different from the data recording speed; and
record a label on the optical media during broadcast of the live program.

29. The medium of claim 28, wherein the instructions further cause the processor to interleave the recording of the live broadcast and the label.

30. A processor-readable medium having processor-executable instructions thereon which, when executed by a processor, cause the processor to:
track a feature on an optical medium indicative of a position on the optical medium;
impinge a first light beam of a first wavelength focused onto a data layer of the optical medium at the position so as to write digital data to or read digital data from the medium; and
simultaneously impinge a second light beam of a second wavelength focused onto a labeling layer of the optical medium at the position, the labeling layer spaced apart from the data layer, so as to form a visible label for the medium.

31. The medium of claim 30, wherein the first light beam is selectively impinged on the data layer in accordance with digital data, and wherein the second light beam is selectively impinged on the data layer in accordance with labeling data.
